(19) United States
(12) Patent Application Publication
(10) Pub. No.: US 2025/0018844 A1
(43) Pub. Date: Jan. 16, 2025

(54) CUSHION SPRING

(71) Applicant: TOYOTA BOSHOKU KABUSHIKI KAISHA, Aichi-ken (JP)

(72) Inventors: Yushi SHINOZAKI, Aichi-ken (JP); Shohei FUNAKI, Aichi-ken (JP); Jun FUKAMI, Aichi-ken (JP); Yoshiomi NISHIGAKI, Aichi-ken (JP); Kouji AKAO, Aichi-ken (JP)

(73) Assignee: TOYOTA BOSHOKU KABUSHIKI KAISHA, Aichi-ken (JP)

(21) Appl. No.: 18/766,950

(22) Filed: Jul. 9, 2024

(30) Foreign Application Priority Data
Jul. 12, 2023 (JP) 2023-114312

(51) Int. Cl. B60N 2/54; B60N 2/68

(52) U.S. Cl. CPC B60N 2/54; B60N 2/68

(57) ABSTRACT

There is provided a cushion spring including: a formed wire bridged to a seat cushion frame in a seat front-rear direction; and a resin member joined to the formed wire. A center wire and a side wire of the formed wire each include a plurality of crank-shaped portions that are bent to fold in a crank shape to one side and the other side in a seat width direction alternately. The resin member includes a deflection restricting portion that connects the plurality of crank-shaped portions to restrict a divergence in the seat front-rear direction between three or more crank-shaped portions, the three or more crank-shaped portions being formed in the side wire and arranged side by side consecutively in the seat front-rear direction.

### CROSS-REFERENCE TO RELATED APPLICATIONS

This application is based on and claims priority under 35 USC 119 from Japanese Patent Application No. 2023-114312 filed on Jul. 12, 2023, the contents of which are incorporated herein by reference.

### TECHNICAL FIELD

The present invention relates to a cushion spring. Specifically, the invention relates to a cushion spring that is bridged to a seat cushion frame in a seat front-rear direction and receives a load of a seated occupant by a surface thereof.

### BACKGROUND ART

JP2019-073115A discloses a cushion spring that is bridged to a seat cushion frame forming a framework of a seat cushion and receives a load of a seated occupant by a surface thereof. The cushion spring includes a pair of left and right formed wires bridged between a frame front portion and a frame rear portion of the seat cushion frame. Each formed wire is folded in a U-shape in a plan view. A center wire and a side wire of each formed wire that are folded are bridged between the frame front portion and frame rear portion of the seat cushion frame so as to extend in a front-rear direction.

In the configuration described in JP2019-073115A, the center wire and the side wire are symmetrical to each other. Therefore, when increasing the roll rigidity of a side portion of the seat cushion, it is necessary to partially hardens a side portion of a cushion pad. However, in a configuration in which the hardness of the cushion pad is partially changed, elasticity weakening, a variation in position, and a variation in hardness are likely to occur in the pad, and the roll rigidity cannot be stably increased. Therefore, the present invention provides a cushion spring capable of appropriately increasing roll rigidity of a side portion of a seat cushion.

### SUMMARY OF INVENTION

To solve the above problems, a cushion spring according to the present invention is configured as follows.

According to a first aspect of the present disclosure, a cushion spring configured to receive a load of a seated occupant by a surface of the cushion spring includes: a formed wire configured to be bridged to a seat cushion frame in a seat front-rear direction; and a resin member that is joined to the formed wire. The formed wire is formed of one wire having a center wire and a side wire that are arranged side by side in a seat width direction and extend in the seat front-rear direction such that one ends of the center wire and the side wire are connected to each other. The center wire and the side wire are arranged in an order of the center wire and the side wire from a center of the seat cushion frame to an outer side in the seat width direction. The center wire and the side wire each include a plurality of crank-shaped portions that are bent to fold in a crank shape to one side and the other side in the seat width direction alternately. The resin member includes a deflection restricting portion that connects the plurality of crank-shaped portions to restrict a divergence in the seat front-rear direction between three or more crank-shaped portions, the three or more crank-shaped portions being formed in the side wire and arranged side by side consecutively in the seat front-rear direction.

According to the first aspect of the present invention, the deflection restricting portion of the resin member effectively restricts the deflection of the crank-shaped portion formed in the side wire. Accordingly, the side wire is less likely to sink downward when a load of a seated occupant is received by a surface thereof. As a result, roll rigidity of a side portion of a seat cushion is appropriately increased.

According to a second aspect of the present disclosure, in the first aspect, the resin member has a pad supporting surface configured to support a seat cushion pad from a back side of the seat cushion pad at a position higher than the plurality of crank-shaped portions.

According to the second aspect of the present invention, the pad supporting surface formed on the resin member can function as a receiving surface when the load of the seated occupant is applied to the side portion of the seat cushion. Since the pad supporting surface is provided integrally with the side wire of the cushion spring whose deflection is restricted, the pad supporting surface is less likely to sink downward and can stably receive the load.

According to a third aspect of the present disclosure, in the first or second aspect, the deflection restricting portion extends to continuously connect all the crank-shaped portions in the seat front-rear direction.

According to the third aspect of the present invention, it is possible to more effectively restrict the side wire from sinking downward. As a result, the roll rigidity of the side portion of the seat cushion can be more appropriately increased.

According to a fourth aspect of the present disclosure, in the third aspect, the deflection restricting portion includes an expanding portion that is expanded such that a connecting width in the seat width direction of a portion connecting the crank-shaped portions is continuously or intermittently increased toward a seat rear side on an inner side in the seat width direction.

According to the fourth aspect of the present invention, the hardness of the side portion of the seat cushion can be adjusted such that the roll rigidity increases toward the seat rear side where a pressure by sitting of the seated occupant is higher, and the roll rigidity decreases toward a seat front side where the pressure by sitting of the seated occupant is lower. Accordingly, it is possible to achieve both the improvement of the sitting comfort when seated and the improvement of the roll rigidity.

According to a fifth aspect of the present disclosure, in the fourth aspect, the expanding portion expands beyond at least one of the crank-shaped portions on the inner side in the seat width direction.

According to the fifth aspect of the present invention, the roll rigidity of the side portion of the seat cushion can be more appropriately increased in a region where the expanding portion extends beyond the crank-shaped portion on the inner side in the seat width direction.

According to a sixth aspect of the present disclosure, in the first or second aspect, the formed wire has a symmetrical shape in the seat width direction, and the formed wire includes a pair of formed wires provided to be symmetrical to each other in the seat width direction with respect to the seat cushion frame.

According to the sixth aspect, since the formed wire has a symmetrical shape, the formed wire can be easily formed. Further, it is possible to relatively easily increase the roll rigidity of both side portions of the seat cushion symmetrically in the seat width direction.

### BRIEF DESCRIPTION OF DRAWINGS

FIG. 1 is a perspective view of illustrating a schematic configuration of a cushion spring according to a first embodiment.

FIG. 2 is a perspective view of illustrating an internal framework of a seat cushion.

FIG. 3 is a perspective view of the cushion spring.

FIG. 4 is a perspective view of a formed wire.

FIG. 5 is a plan view of the cushion spring.

FIG. 6 is a cross-sectional view of the seat cushion taken along a line VI-VI in FIG. 5.

### DESCRIPTION OF EMBODIMENTS

Hereinafter, embodiments according to the present invention will be described with reference to the drawings.

### First Embodiment

### Schematic Configuration of Cushion Spring 10

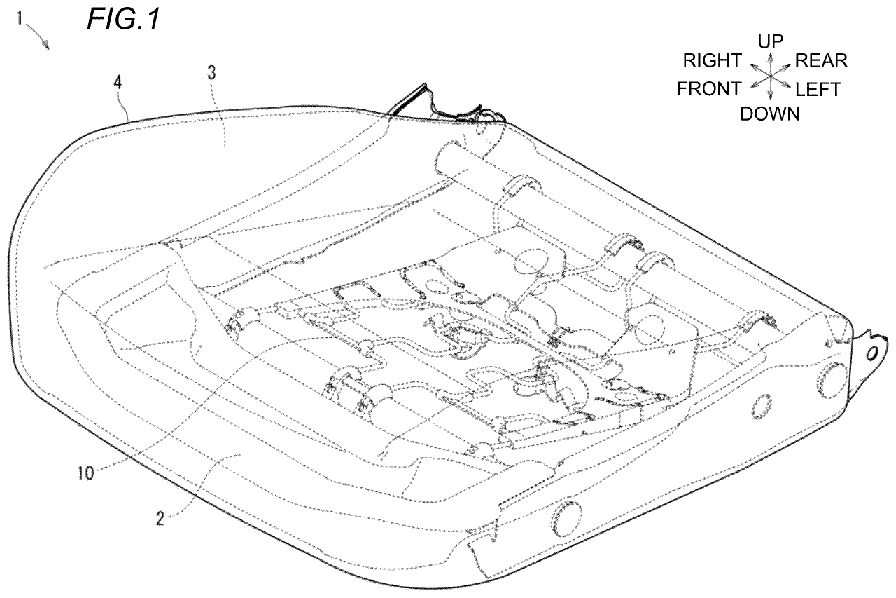

First, a configuration of a cushion spring 10 according to a first embodiment of the present invention will be described with reference to FIGS. 1 to 6. In the following description, when a direction such as front, rear, up, down, left, or right is described, it is assumed that the direction indicates a corresponding direction illustrated in the drawings.

When combinations of the directions with a word “seat” are described such as a “seat width direction”, the combinations indicate directions based on a seat cushion 1. In addition, in the following description, when a specific reference diagram is not described or when there is no corresponding reference numeral in the reference diagram, any one of FIGS. 1 to 6 is referred to as appropriate.

As illustrated in FIG. 1, the cushion spring 10 according to the present embodiment is applied to the seat cushion 1 of an automobile seat. The automobile seat includes a seatback (not illustrated) serving as a backrest for a seated occupant and the seat cushion 1 serving as a seating portion.

The seat cushion 1 is installed on a floor of an automobile (not illustrated). The seat cushion 1 includes a seat cushion frame 2 that forms a framework thereof, a seat cushion pad 3 that covers the seat cushion frame 2 from above, and a seat cushion cover 4 that covers the seat cushion pad 3 from a pad surface side.

The seat cushion 1 further includes the cushion spring 10 that is bridged to the seat cushion frame 2 in a seat front-rear direction. The cushion spring 10 functions as a pad receiving portion that receives a load of a seated occupant by a surface thereof via the seat cushion pad 3.

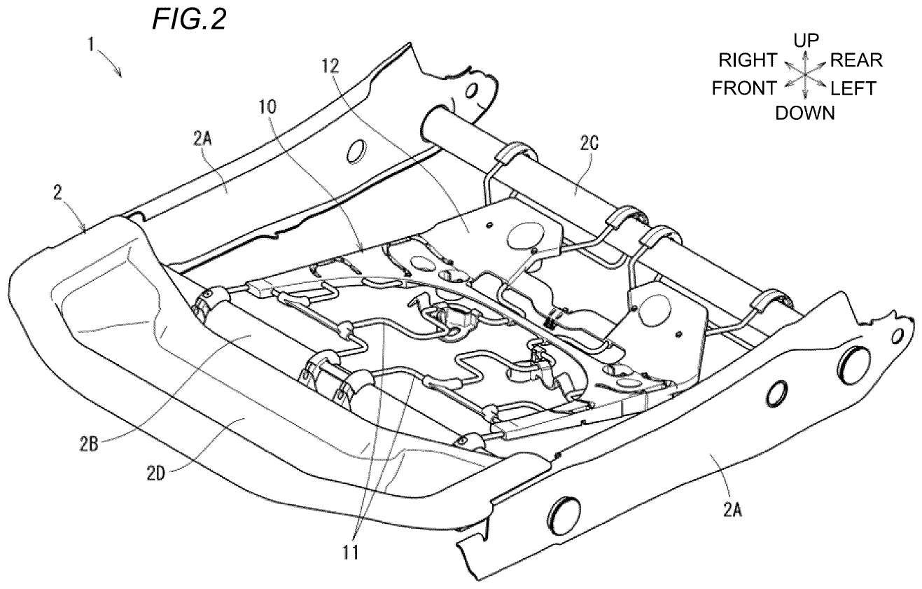

As illustrated in FIG. 2, the seat cushion frame 2 is formed of a metal member assembled in a frame shape in a plan view. Specifically, the seat cushion frame 2 includes lower arms 2A that form left and right side frameworks of the seat cushion 1 and a front pipe 2B that is integrally bridged between front portions of the lower arms 2A. The seat cushion frame 2 further includes a rear pipe 2C that is integrally bridged between rear portions of the lower arms 2A and a front panel 2D that is integrally bridged between upper edges of front ends of the lower arms 2A.

Referring to FIG. 1, the seat cushion pad 3 is formed of a polyurethane foamed body. The seat cushion pad 3 is set in a manner of covering the entire upper portion of the seat cushion frame 2 from above the seat. Accordingly, the seat cushion pad 3 is set such that a peripheral portion thereof is firmly supported by the seat cushion frame 2 from below the seat and a central portion thereof is softly supported by the cushion spring 10 from below the seat.

The seat cushion cover 4 is formed of a planar fabric member. The seat cushion cover 4 covers, from the pad surface side, the seat cushion pad 3 set on the upper portion of the seat cushion frame 2. The seat cushion cover 4 is fixed to the seat cushion frame 2 such that front, rear, left, and right ends of the seat cushion cover 4 are pulled below the seat. Accordingly, the seat cushion cover 4 is widely stretched over the pad surface of the seat cushion pad 3, and holds the seat cushion pad 3 in a state of being pressed against the upper portion of the seat cushion frame 2 and fixed in position.

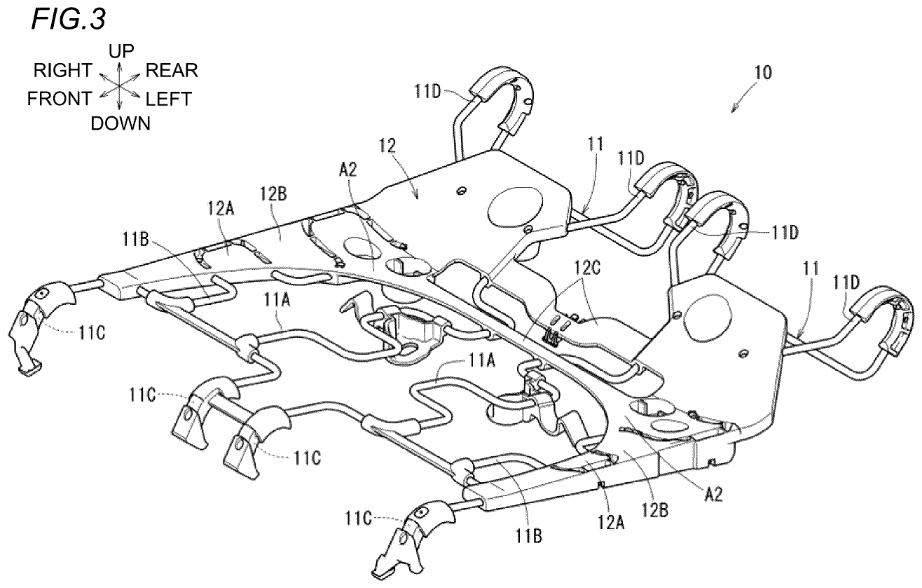

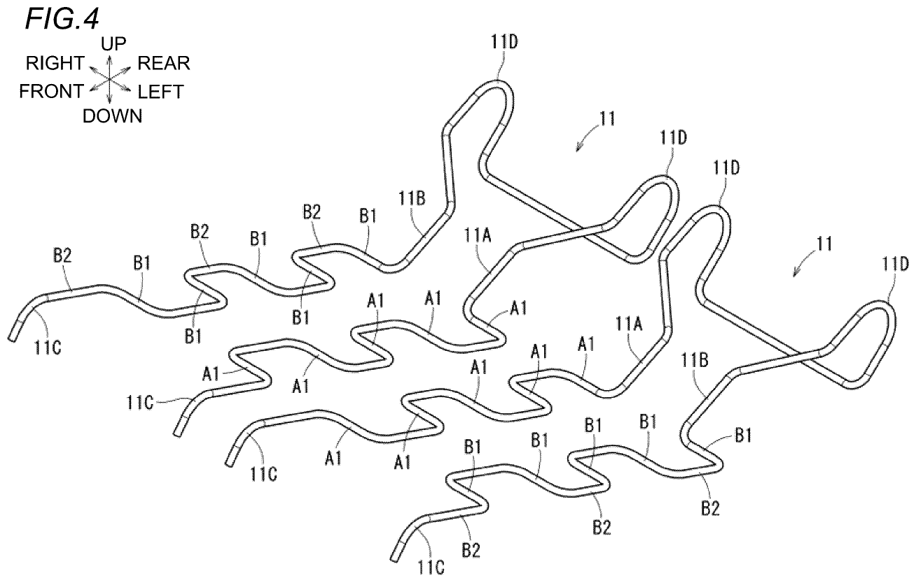

As illustrated in FIG. 3, the cushion spring 10 includes a pair of left and right formed wires 11 each formed of a rod-shaped processed spring bent in a U shape in a plan view, and a resin member 12 joined to each formed wire 11. As illustrated in FIG. 4, each formed wire 11 is formed of one wire bent in a U shape in a plan view.

Specifically, each formed wire 11 is formed of a wire having a U shape in a plan view which is bent to have a center wire 11A and a side wire 11B. The center wire 11A and the side wire 11B are arranged side by side in the seat width direction and extend in the seat front-rear direction. The center wire 11A and the side wire 11B each have a U shape in a plan view in which rear ends thereof are connected to each other and front ends thereof are spaced apart from each other.

Each formed wire 11 has a symmetrical shape in the seat width direction. Further, the formed wires 11 are arranged in a manner of being symmetrical to each other in the seat width direction. As illustrated in FIG. 3, each formed wire 11 is provided such that a wire arranged on a center side of the seat cushion frame 2 in the seat width direction is defined as the center wire 11A and a wire arranged on an outer side is defined as the side wire 11B.

At each of the front ends of the center wire 11A and the side wire 11B of each formed wire 11, a front hooking portion 11C is formed that is bent in a shape allowing the front hooking portion 11C to be hooked on the front pipe 2B from above. Further, at each of the rear ends of the center wire 11A and the side wire 11B of each formed wire 11, a rear hooking portion 11D is formed that is bent in a shape allowing the rear hooking portion 11D to be hooked on the rear pipe 2C from above.

As illustrated in FIG. 4, the center wire 11A of each formed wire 11 is formed with a plurality of crank-shaped portions A1 that are bent in a manner of folding in a crank shape to one side and the other side in the seat width direction alternately, and the side wire 11B of each formed wire 11 is formed with a plurality of crank-shaped portions B1 that are bent in a manner of folding to one side and the other side in the seat width direction alternately. In each formed wire 11, the crank-shaped portions A1 formed in the center wire 11A and the crank-shaped portions B1 formed in the side wire 11B are formed symmetrically in the seat width direction such that the crank-shaped portions A1 and B1 approach or separate from each other in the seat width direction.

With the crank-shaped portions A1 and B1, each formed wire 11 has a shape extending in the seat width direction as well as in the seat front-rear direction. Accordingly, each formed wire 11 is able to planarly support the seat cushion pad 3 (see FIG. 1) from a pad back side.

Each formed wire 11 is formed such that the center wire 11A and the side wire 11B thereof are bent in a V shape in a side view. With the bending in the V shape, each formed wire 11 allows a rear portion (a portion where the pad thickness is increased downward) of the seat cushion pad 3 (see FIG. 1), which supports the ischium of the seated occupant, to sink deeply downward.

As illustrated in FIG. 3, the resin member 12 is joined to the formed wires 11 in a manner of being symmetrical in the seat width direction. Specifically, the resin member 12 includes a pair of deflection restricting portions 12A that are joined to the formed wires 11 in a manner of extending in the seat front-rear direction along the side wires 11B respectively.

Further, the resin member 12 has a pad supporting surface 12B that forms an upper surface of each deflection restricting portion 12A. Each pad supporting surface 12B is formed at a position higher than the side wire 11B, and forms a support surface that planarly supports the seat cushion pad 3 (see FIG. 1) from the pad back side.

The resin member 12 further includes a connecting portion 12C extending in the seat width direction to connect rear portions of the deflection restricting portions 12A. The resin member 12 is integrally joined to the formed wires 11 by integral molding with the formed wires 11.

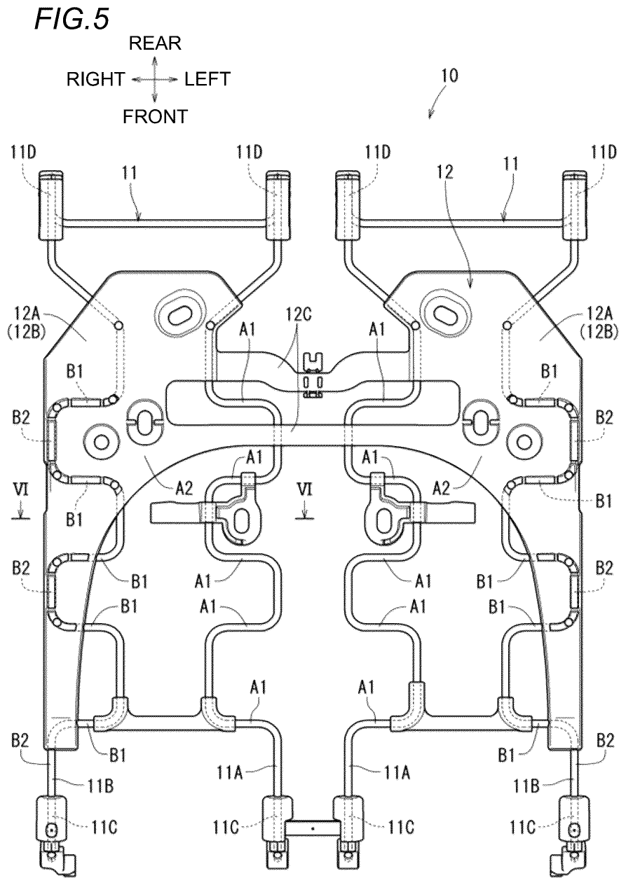

Next, a detailed configuration of the resin member 12 will be described. As illustrated in FIG. 5, each deflection restricting portion 12A is formed in a manner of continuously extending in the seat front-rear direction along linear longitudinal wire portions B2 of the corresponding side wire 11B. The longitudinal wire portions B2 extend intermittently in the seat front-rear direction between the corresponding front hooking portion 11C and the corresponding rear hooking portion 11D. The longitudinal wire portions B2 of each side wire 11B are formed at positions on the same straight line.

Accordingly, each deflection restricting portion 12A is formed to connect all the crank-shaped portions B1 of the corresponding side wire 11B that are adjacent to each other in the front-rear direction. Each deflection restricting portion 12A includes an expanding portion A2 that is expanded such that a connecting width in the seat width direction of a portion connecting the crank-shaped portions B1 is continuously increased toward the seat rear side on an inner side in the seat width direction.

Each expanding portion A2 has a shape of expanding so as to define an inner peripheral edge in a recessed curved surface shape in a plan view along an outer edge of the hip portion of a seated person. With the expanding portion A2, each deflection restricting portion 12A has a shape in which a connecting width of a portion connecting the foremost crank-shaped portion B1 and the second crank-shaped portion B1 counting from the front of each side wire 11B is the smallest.

Each deflection restricting portion 12A has a shape in which a connecting width of a portion connecting the second crank-shaped portion B1 from the front and the third crank-shaped portion B1 from the front of the corresponding side wire 11B is wider. Each deflection restricting portion 12A has a shape in which a connecting width of a portion connecting the third crank-shaped portion B1 from the front and the fourth crank-shaped portion B1 from the front of the corresponding side wire 11B is further wider.

Specifically, each deflection restricting portion 12A has a shape of, at the middle of a portion connecting the third crank-shaped portion B1 from the front and the fourth crank-shaped portion B1 from the front of each side wire 11B, expanding beyond the third crank-shaped portion B1 and the fourth crank-shaped portion B1 on the inner side in the seat width direction and being connected to the connecting portion 12C. In this sense, each expanding portion A2, which expands beyond the third crank-shaped portion B1 from the front and the fourth crank-shaped portion B1 from the front on the inner side in the seat width direction from the middle of the portion connecting the third crank-shaped portion B1 and the fourth crank-shaped portion B1, is a part of the connecting portion 12C.

Each deflection restricting portion 12A is not formed at a portion (not illustrated) that supports the ischium of the seated occupant, and is formed at a position retracted to the outer side in the seat width direction from the portion that supports the ischium. The connecting portion 12C is not formed at the portion (not illustrated) that supports the ischium of the seated occupant, and is formed at a position that is retracted to the seat rear side from the portion that supports the ischium.

With the deflection restricting portion 12A, a divergence between the crank-shaped portions B1 arranged by five in the front-rear direction of each side wire 11B of each formed wire 11 is restricted. Specifically, in each side wire 11B, the divergence in the seat front-rear direction between the foremost crank-shaped portion B1 and the second crank-shaped portion B1 from the front is restricted on a lowest level by the shape in which the connecting width of the corresponding deflection restricting portion 12A changes.

Further, in each side wire 11B, the divergence in the seat front-rear direction between the second crank-shaped portion B1 from the front and the third crank-shaped portion B1 from the front is restricted on a high level. Further, in each side wire 11B, the divergence in the seat front-rear direction between the third crank-shaped portion B1 from the front and the fourth crank-shaped portion B1 from the front is restricted on a higher level.

Further, in each side wire 11B, since the fourth crank-shaped portion B1 from the front and the fifth crank-shaped portion B1 from the front are connected to each other over the entire region in the seat width direction by the corresponding deflection restricting portion 12A, the divergence in the seat front-rear direction therebetween is completely restricted. With the resin member 12, even when the formed wires 11 are formed symmetrically to each other in the seat width direction, the cushion spring 10 has different flexibility in the center wire 11A and the side wire 11B of each formed wire 11 at the time of receiving a load from the seated occupant.

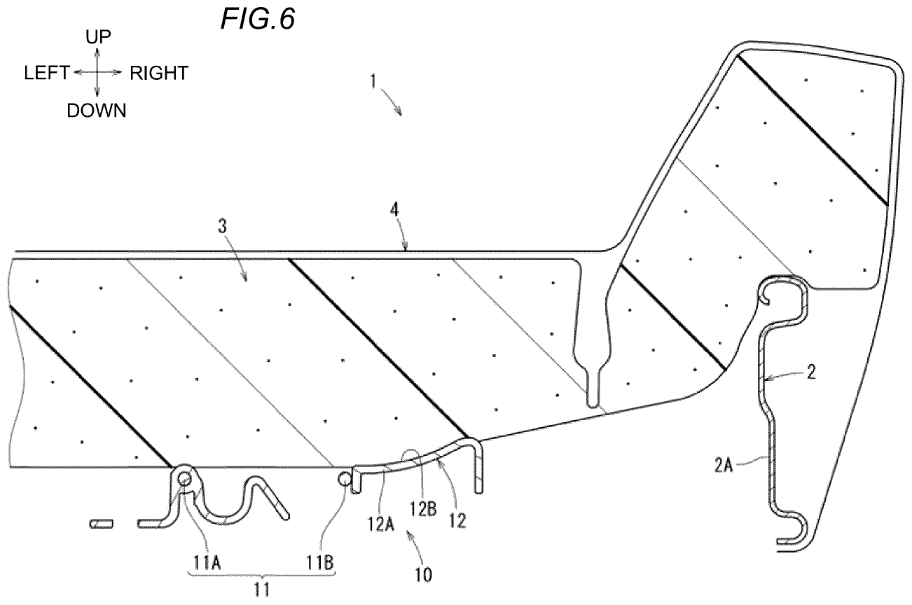

Specifically, as illustrated in FIG. 6, when the cushion spring 10 receives a load from the seated occupant, each center wire 11A is deflected in a manner of sinking downward relatively flexibly. On the other hand, deflection of each side wire 11B is restricted so that the side wire 11B is less likely to sink downward than each center wire 11A.

Specifically, the load from the seated occupant decreases from the rear portion of the seat toward the front portion of the seat, and the level of deflection restriction of each side wire 11B gets lower toward the front side and gets higher toward the rear side by the shape in which the connecting width of each deflection restricting portion 12A changes. Accordingly, the roll rigidity of each side portion of the seat cushion 1 can be appropriately increased.

The pad supporting surface 12B forming the upper surface of each deflection restricting portion 12A functions as a receiving surface of the seat cushion pad 3 when the load of the seated occupant is applied to each side portion of the seat cushion 1. Since each pad supporting surface 12B is provided integrally with the corresponding side wire 11B of the cushion spring 10 whose deflection is restricted, the pad supporting surfaces 12B are less likely to sink downward and can stably receive the load.

More specifically, since the pad supporting surfaces 12B are integrally connected to each other by the connecting portion 12C, when a load from the seated occupant is applied to one pad supporting surface 12B, the load is also transmitted to the side wire 11B on the opposite side via the other pad supporting surface 12B. Accordingly, when the load of the seated occupant is applied to the side portions of the seat cushion 1, the pad supporting surfaces 12B are less likely to sink downward and can stably receive the load.

As illustrated in FIG. 5, a groove, which is recessed along the shape of each side wire 11B and formed in each pad supporting surface 12B, is a groove through which a pressing pin for fixing the position of the corresponding formed wire 11 in a mold of the resin member 12 is passed.

To summarize the above, the cushion spring 10 according to the present embodiment may have the following configuration. In the following description, reference signs assigned in parentheses correspond to the configurations described in the above embodiment.

That is, a cushion spring (10) is a spring that is bridged to a seat cushion frame (2) in a seat front-rear direction and receives a load of a seated occupant by a surface thereof. The cushion spring (10) includes a formed wire (11) that is bridged to the seat cushion frame (2) in the seat front-rear direction, and a resin member (12) that is joined to the formed wire (11).

The formed wire (11) is formed of a single wire having a center wire (11A) and a side wire (11B). The center wire (11A) and the side wire (11B) are arranged side by side in a seat width direction and extend in the seat front-rear direction so that one ends thereof are connected to each other. The center wire (11A) and the side wire (11B) are arranged in this order from a center of the seat cushion frame (2) to an outer side in the seat width direction.

The center wire (11A) and the side wire (11B) each include a plurality of crank-shaped portions (A1, B1) that are bent in a manner of folding in a crank shape to one side and the other side in the seat width direction alternately. The resin member (12) includes a deflection restricting portion (12A) that connects the plurality of crank-shaped portions (B1) to restrict a divergence in the seat front-rear direction between three or more crank-shaped portions (B1), the three or more crank-shaped portions (B1) being formed in the side wire (11B) and arranged side by side consecutively in the front-rear direction.

According to the above configuration, the deflection restricting portion (12A) of the resin member (12) effectively restricts the deflection of the crank-shaped portion (B1) formed in the side wire (11B). Accordingly, the side wire (11B) is less likely to sink downward when a load of a seated occupant is received by a surface thereof. As a result, roll rigidity of a side portion of a seat cushion (1) is appropriately increased.

Further, the resin member (12) has, at a position higher than the plurality of crank-shaped portions (B1), a pad supporting surface (12B) that supports a seat cushion pad (3) from a pad back side on a surface basis. According to the above configuration, the pad supporting surface (12B) formed on the resin member (12) can function as a receiving surface when the load of the seated occupant is applied to the side portion of the seat cushion (1). Since the pad supporting surface (12B) is provided integrally with the side wire (11B) of the cushion spring (10) whose deflection is restricted, the pad supporting surface (12B) is less likely to sink downward and can stably receive the load.

Further, the deflection restricting portion (12A) extends in a manner of continuously connecting all the crank-shaped portions (B1) in the seat front-rear direction. According to the above configuration, it is possible to more effectively restrict the side wire (11B) from sinking downward. As a result, the roll rigidity of the side portion of the seat cushion (1) can be more appropriately increased.

Further, the deflection restricting portion (12A) includes an expanding portion (A2) that is expanded such that a connecting width in the seat width direction of a portion connecting the crank-shaped portions (B1) is continuously increased toward a seat rear side on an inner side in the seat width direction. According to the above configuration, the hardness of the side portion of the seat cushion (1) can be adjusted such that the roll rigidity increases toward the seat rear side where a pressure by sitting of the seated occupant is higher, and the roll rigidity decreases toward a seat front side where the pressure by sitting of the seated occupant is lower. Accordingly, it is possible to achieve both the improvement of the sitting comfort when seated and the improvement of the roll rigidity.

Further, the expanding portion (A2) expands beyond the crank-shaped portion (B1) on the inner side in the seat width direction. According to the above configuration, the roll rigidity of the side portion of the seat cushion (1) can be more appropriately increased in a region where the expanding portion (A2) extends beyond the crank-shaped portion (B1) on the inner side in the seat width direction.

Further, a pair of the formed wires (11) are provided that are symmetrical to each other in the seat width direction with respect to the seat cushion frame (2) and each of which has a symmetrical shape in the seat width direction. According to the above configuration, since the formed wire (11) has a symmetrical shape, the formed wire (11) can be easily formed. Further, it is possible to relatively easily increase the roll rigidity of both side portions of the seat cushion (1) symmetrically in the seat width direction.

### Regarding Other Embodiments

Although the embodiment of the present invention has been described above with reference to one embodiment, the present invention can be implemented in various embodiments other than the above embodiment.

1. The cushion spring according to the present invention is applicable not only to a seat cushion of a seat to be mounted on a vehicle such as an automobile or a railroad vehicle, but also to a seat cushion of a seat to be mounted on other vehicles such as an aircraft or a ship. The cushion spring is also applicable to a seat cushion of a seat not to be mounted on a vehicle.

2. In the cushion spring, the pair of formed wires may not necessarily be provided to be symmetrical to each other in the seat width direction with respect the seat cushion frame. That is, one formed wire may have a shape different from that of the other formed wire. Further, in the formed wire, the center wire and the side wire may not necessarily be symmetrical to each other in the seat width direction.

3. The pad supporting surface of the resin member may form the upper surface of the deflection restricting portion, or may form an upper surface of a region separated from the deflection restricting portion. It is sufficient that the deflection restricting portion connects the plurality of crank-shaped portions to restrict the divergence in the seat front-rear direction between three or more crank-shaped portions arranged side by side consecutively. Accordingly, the deflection restricting portion may have a configuration of directly connecting only the foremost crank-shaped portion and the rearmost crank-shaped portion among the three or more crank-shaped portions arranged side by side consecutively and not connecting the crank-shaped portions located therebetween.

The expanding portion of the deflection restricting portion may be formed such that the connecting width in the seat width direction of the portion connecting the crank-shaped portions is continuously increased toward the seat rear side on the inner side in the seat width direction, or may be formed such that the connecting width is intermittently increased. That is, the expanding portion may be provided with a region in which the connecting width is partially narrowed or kept constant. Further, the deflection restricting portion may have a shape in which the connecting width is constant over the entire region in the seat front-rear direction or the connecting width is increased toward the seat front side.

What is claimed is:

1. A cushion spring configured to receive a load of a seated occupant by a surface of the cushion spring, the cushion spring comprising:
a formed wire configured to be bridged to a seat cushion frame in a seat front-rear direction; and
a resin member that is joined to the formed wire, wherein
the formed wire is formed of one wire having a center wire and a side wire that are arranged side by side in a seat width direction and extend in the seat front-rear direction such that one ends of the center wire and the side wire are connected to each other,
the center wire and the side wire are arranged in an order of the center wire and the side wire from a center of the seat cushion frame to an outer side in the seat width direction,
the center wire and the side wire each include a plurality of crank-shaped portions that are bent to fold in a crank shape to one side and the other side in the seat width direction alternately, and
the resin member includes a deflection restricting portion that connects the plurality of crank-shaped portions to restrict a divergence in the seat front-rear direction between three or more crank-shaped portions, the three or more crank-shaped portions being formed in the side wire and arranged side by side consecutively in the seat front-rear direction.

2. The cushion spring according to claim 1, wherein
the resin member has a pad supporting surface configured to support a seat cushion pad from a back side of the seat cushion pad at a position higher than the plurality of crank-shaped portions.

3. The cushion spring according to claim 1, wherein
the deflection restricting portion extends to continuously connect all the crank-shaped portions in the seat front-rear direction.

4. The cushion spring according to claim 3, wherein
the deflection restricting portion includes an expanding portion that is expanded such that a connecting width in the seat width direction of a portion connecting the crank-shaped portions is continuously or intermittently increased toward a seat rear side on an inner side in the seat width direction.

5. The cushion spring according to claim 4, wherein
the expanding portion expands beyond at least one of the crank-shaped portions on the inner side in the seat width direction.

6. The cushion spring according to claim 1, wherein
the formed wire has a symmetrical shape in the seat width direction, and
the formed wire includes a pair of formed wires provided to be symmetrical to each other in the seat width direction with respect to the seat cushion frame.

7. The cushion spring according to claim 2, wherein
the pad supporting surface includes a groove recessed along a shape of the side wire.
